(19) United States
(12) Patent Application Publication
(10) Pub. No.: US 2023/0158986 A1
(43) Pub. Date: May 25, 2023

(54) DIVIDER PANEL SYSTEM FOR VEHICLE

(71) Applicant: EV FLEET SERVICES LLC, Delaware, OH (US)

(72) Inventor: Zachary Ian Wilson, Delaware, OH (US)

(21) Appl. No.: 18/057,309

(22) Filed: Nov. 21, 2022

Related U.S. Application Data
(60) Provisional application No. 63/264,485, filed on Nov. 23, 2021.
(60) Provisional application No. 63/264,486, filed on Nov. 23, 2021.
(60) Provisional application No. 63/264,481, filed on Nov. 23, 2021.

(51) Int. Cl. B60R 21/02; B60R 7/04

(52) U.S. Cl. CPC B60R 21/026; B60R 7/04

(57) ABSTRACT

A system of divider panels for a vehicle is provided. The system includes a first divider panel that separates a front seating area from a rear seating area of the vehicle. A second divider panel separates the rear seating area from a cargo area of the vehicle. A third divider panel separates the rear seating area into two separate areas. The first, second and third dividers may be removably coupled in the interior cabin of the vehicle by mounting points defined in the roof of the vehicle, the floor of the vehicle, and seating support structure of the vehicle.

### CROSS-REFERENCE TO RELATED APPLICATIONS

This application claims priority to U.S. Provisional Application No. 63/264,485, filed on Nov. 23, 2021, entitled “Divider Panel System for Vehicle,” and to U.S. Provisional Application No. 63/264,481, filed on Nov. 23, 2021, entitled “Roof System for Vehicle,” and to U.S. Provisional Application No. 63/264,486, filed on Nov. 23, 2021, entitled “Public Safety Vehicle,” the disclosures of which are incorporated herein by reference in their entireties.

### FIELD

This document relates, generally, to divider panels for a motor vehicle, and in particular to divider panels that can be secured into a roof panel of the motor vehicle to partition the interior cabin of the motor vehicle.

### BACKGROUND

A motor vehicle typically includes a body and a roof coupled to the body. The body and the roof may define, for example, an interior cabin, an engine compartment, a cargo compartment and the like.

### SUMMARY

In one general aspect, a divider system for a vehicle includes a first divider panel configured to be removably coupled in a first portion of an interior cabin of a vehicle, wherein the first divider panel extends between a roof portion and a floor portion of the vehicle, and between a first lateral side portion and a second lateral side portion of the vehicle, to separate a first cabin area and a second cabin area of the interior cabin of the vehicle, the first divider panel including a first panel section defining an upper portion of the first divider panel; a second panel section coupled to the first panel section and defining a lower portion of the first divider panel; a first coupling portion provided at an upper end portion of the first panel section, including a plurality of protrusions configured to be removably received in corresponding mounting points formed in the roof portion of the vehicle; and a second coupling portion provided at a lower end portion of the second panel section, including a plurality of openings configured to provide for removable coupling of the lower end portion of the second panel section to the floor portion of the vehicle, wherein the first divider panel is configured to be supported in the interior cabin of the vehicle via the coupling of the first panel section to the roof portion and the second panel section to the floor portion of the vehicle, independent of a first support pillar and a second support pillar respectively provided at the first lateral side portion and the second lateral side portion of the vehicle.

In some implementations, the divider system includes at least one bracket coupled to a corresponding rail structure fixed to the floor portion of the vehicle, wherein the second coupling portion of the first divider panel is configured to be removably coupled to the rail structure via the at least one bracket.

In some implementations, the at least one bracket includes a first bracket coupled to a first rail structure supporting a first seat in the first cabin area; and a second bracket coupled to a second rail structure supporting a second seat in the first cabin area.

In some implementations, a plurality of fasteners extend through the plurality of openings in the second coupling portion of the first divider and into the first bracket and the second bracket to removably couple the lower portion of the first divider to the floor portion of the vehicle.

In some implementations, the first panel section of the first divider panel includes a rigid frame surrounding a rigid material that is at least partially transparent.

In some implementations, the divider system includes a second divider panel configured to divide the second cabin area from a third cabin area of the interior cabin of the vehicle, the second divider panel including a third coupling portion provided at an upper end portion of the second divider panel and configured to be removably coupled to the roof portion of the vehicle; and a fourth coupling portion provided at a lower end portion of the second divider panel and configured to be removably coupled to corresponding mounting points provided in a rear seat support structure of the vehicle.

In some implementations, the third coupling portion is configured to be removably secured between a frame portion of the third cabin area and a door of the third cabin area.

In some implementations, the third coupling portion includes a plurality of protrusions configured to be removably received in corresponding mounting points formed in the roof portion of the vehicle.

In some implementations, the second divider panel includes a rigid frame surrounding a rigid material that is at least partially transparent.

In some implementations, the divider system includes a third divider panel configured to divide the second cabin area into a first section and a second section, the third divider panel including a fifth coupling portion provided at an upper end portion of the third divider panel, including a plurality of protrusions configured to be removably received in corresponding mounting points formed in the roof portion of the vehicle; and a sixth coupling portion provided at a lower end portion of the third divider panel and configured to removably couple the lower end portion of the third divider panel to the floor portion of the vehicle.

In some implementations, the divider system includes at least one fastener extending through at least one corresponding opening in the sixth coupling portion and into at least one corresponding mounting point in the floor portion of the vehicle to removably couple the lower end portion of the third divider panel to the floor portion of the vehicle.

In some implementations, the divider system includes a seventh coupling portion at a rear end portion of the third divider panel and configured to removably couple the rear end portion of the third divider panel to a corresponding portion of a seat installed in the second cabin area.

In some implementations, the divider system includes at least one fastener extending through at least one corresponding opening in the seventh coupling portion and into at least one corresponding mounting point in the seat installed in the second cabin area to removably couple the rear end portion of the third divider panel to the seat.

In some implementations, the first divider panel is configured to restrict access between the first cabin area and the second cabin area; the second divider panel is configured to restrict access between the second cabin area and the third cabin area; and the third divider panel is configured to restrict access between the first section and the second section of the second cabin area.

In some implementations, the first cabin area is a front seating area of the vehicle; the second cabin area is a rear seating area of the vehicle; and the third cabin area is a cargo area of the vehicle.

In another general aspect, a method of installing a divider system in a vehicle includes installing a first divider panel in an interior cabin of the vehicle, independent of a first support pillar and a second support pillar respectively provided at a first lateral side portion and a second lateral side portion of the vehicle, to separate a first cabin area from a second cabin area of the interior cabin, including coupling a first coupling portion at an upper end portion of the first divider panel to a roof portion of the interior cabin, including removably inserting a plurality of protrusions at the upper end portion of the first divider panel into a corresponding plurality of mounting points formed in a roof portion of the interior cabin; and securing a second coupling portion at a lower end portion of the first divider panel to a floor portion of the interior cabin, including removably fastening the second coupling portion to at least one rail structure coupled to the floor portion of the interior cabin.

In some implementations, securing the second coupling portion of the first divider panel to the floor portion of the interior cabin includes installing a plurality of fasteners through a plurality of openings in the second coupling portion and into a first bracket coupled to a first rail structure and a second bracket coupled to a second rail structure, the first rail structure securing a first seat in the first cabin area to the floor portion of the interior cabin, and the second rail structure securing a second seat in the first cabin area to the floor structure of the interior cabin.

In some implementations, the method includes installing a second divider panel in the interior cabin, to separate the second cabin area from a third cabin area of the vehicle, including:

positioning a third coupling portion at an upper end portion of the second divider panel between a frame and a door coupled to the frame, the frame being positioned between the second cabin area and the third cabin area, and the door being coupled to the frame for access to the third cabin area; and installing a plurality of fasteners through a plurality of openings in a fourth coupling portion at a lower end portion of the third divider panel and into an upper end portion of a seat in the second cabin area.

In some implementations, the method includes installing a third divider panel in the second cabin area of the interior cabin, including coupling a fifth coupling portion at an upper end portion of the third divider panel to a roof portion of the interior cabin, including removably inserting a plurality of protrusions at the upper end portion of the third divider panel into a corresponding plurality of mounting points formed in the roof portion of the interior cabin; and securing a sixth coupling portion at a lower end portion of the third divider panel to a floor portion of the interior cabin, including removably fastening the second coupling portion to the floor portion of the interior cabin.

In some implementations, the third divider panel extends from the first divider panel to the second divider panel to separate the second cabin area into a first section and a second section. The details of one or more implementations are set forth in the accompanying drawings and the description below. Other features will be apparent from the description and drawings, and from the claims.

### BRIEF DESCRIPTION OF THE DRAWINGS

FIG. 1A is a partial view of an interior cabin of an example vehicle, illustrating an example first divider panel installed in the example vehicle, in accordance with implementations described herein.

FIG. 1B(1) is a partial view of the interior cabin of the example vehicle shown in FIG. 1A, illustrating an example second divider panel installed in the example vehicle, in accordance with implementations described herein.

FIG. 1B(2) is a partial view of a cargo compartment of the example vehicle shown in FIG. 1A, illustrating the example divider panel as viewed from the cargo compartment.

FIG. 1C(1) is a partial view of the interior cabin of the example vehicle, illustrating an example third divider panel installed in the example vehicle, in accordance with implementations described herein.

FIG. 1C(2) illustrates the third divider panel, as viewed from a front passenger area of the interior cabin of the example vehicle.

FIG. 2A(1) is a plan view of a first configuration of the example first divider panel shown in FIG. 1A, in accordance with implementations described herein.

FIG. 2A(2) is a plan view of a second configuration of the example first divider panel shown in FIG. 1A, in accordance with implementations described herein.

FIG. 2B is a side view of the example first divider panel shown in FIG. 1A, in accordance with implementations described herein.

FIGS. 2C(1) and 2C(2) are close in views of a top portion of the example first divider panel shown in FIGS. 2A(2)-2B, illustrating the coupling of the top portion of the example first divider panel to a roof portion of an example vehicle, in accordance with implementations described herein.

FIG. 2D illustrates an example bracket, in accordance with implementations described herein.

FIG. 2E illustrates the example bracket shown in FIG. 2D, coupled to an example front seat support rail structure of the example vehicle, in accordance with implementations described herein.

FIG. 2F is a close in view of a bottom portion of the example first divider panel shown in FIGS. 2A(1)-2B, illustrating the coupling of the bottom portion of the example first divider panel to the example bracket and the example front seat support rail structure of the example vehicle, in accordance with implementations described herein.

FIG. 3A(1) is a plan view of a first configuration of the example second divider panel shown in FIGS. 1B(1) and 1B(2), in accordance with implementations described herein.

FIG. 3A(2) is a plan view of a second configuration of the example second divider panel shown in FIGS. 1B(1) and 1B(2), in accordance with implementations described herein.

FIG. 3B illustrates the coupling of a top portion of the second divider panel shown in FIGS. 3A(1)-3A(2) to a roof portion of an example vehicle, in accordance with implementations described herein.

FIG. 3C illustrates the coupling of a bottom portion of the second divider panel shown in FIGS. 3A(1)-3A(2) to a rear seat portion of an example vehicle, in accordance with implementations described herein.

FIGS. 4A(1) and 4A(2) are plan views of the example third divider panel shown in FIGS. 1C(1)-1C(2), in accordance with implementations described herein.

FIGS. 4B(1) and 4B(2) illustrate the coupling of a top portion of the third divider panel shown in FIGS. 4A(1) and 4A(2) to a roof portion of an example vehicle, in accordance with implementations described herein.

FIG. 4C illustrates the coupling of a bottom portion of the third divider panel shown in FIGS. 4A(1) and 4A(2) to a floor portion of an example vehicle, in accordance with implementations described herein.

FIG. 4D illustrates the coupling of a rear portion of the third divider panel to a rear seat portion and/or the example second divider panel, in accordance with implementations described herein.

FIG. 5 is a top view of an example vehicle, with a roof portion removed, illustrating an arrangement of an example first divider panel, an example second divider panel, and an example third divider panel, installed in the example vehicle, in accordance with implementations described herein.

FIGS. 6A-6H are various additional views of the interior cabin of the example vehicle, illustrating an arrangement of an example first divider panel, and example second divider panel, and an example third divider panel, installed in the example vehicle, in accordance with implementations described herein.

### DETAILED DESCRIPTION

In configuring a vehicle for a particular use or application, it may be desirable to separate an interior cabin of the vehicle into separate areas, or compartments, for example, in a manner in which at least some, or all, of the compartments inaccessible from another of the compartments. For example, a vehicle to be equipped and/or configured for use as a public safety vehicle may benefit from the ability to separate, or establish a barrier between a rear seating area and a front seating area, and/or between the rear seating area and a cargo compartment of the vehicle. Such barriers may restrict access to the front seating area and/or the cargo compartment from the rear seating area, and in particular may restrict access to the front seating area and/or the cargo compartment by a passenger in the rear seating area. Similarly, a vehicle to be equipped and/or configured for use as a public safety vehicle may benefit from the ability to separate, or divide the rear seating area into separate seating areas. Such dividers may restrict access between seating sections in the rear seating area, to isolate one rear seat passenger from another rear seat passenger, to restrict access to equipment and the like stored in one of the seating sections, and the like.

A system of divider panels, in accordance with implementations described herein, may be coupled to an interior cabin of a vehicle, to selectively divide the interior cabin into separate containment areas within the interior cabin of the vehicle. Installation of the divider panels may restrict access between the separate containment areas within the interior cabin of the vehicle. The installation of one or more divider panels in the interior cabin of the vehicle to restrict access between compartments and/or isolate compartments in the interior cabin of the vehicle from each other may allow the vehicle to be configured for a particular application. Such applications may include, for example, a public safety application in which passenger(s) held in the rear seating area are to be isolated from public safety officer(s) in the front seating area of the vehicle, passenger(s) held in the rear seating area are to be isolated from each other and/or from equipment stored in the cargo compartment and/or the rear seating area, and the like. In some implementations, the system may include a first divider panel that provides a barrier between the rear seating area and the front seating area of the interior cabin of the vehicle. In some implementations, the system may include a second divider panel that provides a barrier between the rear seating area and the cargo compartment of the vehicle. In some implementations, the system may include a third divider panel that extends between the first divider panel and the second divider panel to provide a barrier between a first section of the rear seating area and a second section of the rear seating area.

In some implementations, one or more of the divider panels may be secured at a first end portion thereof to a roof portion of the vehicle. For example, the roof portion of the vehicle may include mounting points configured to specifically receive and secure coupling portions of the divider panels, to facilitate the installation of the divider panels in the interior cabin of the vehicle. One or more of the divider panels may be secured at a second end portion thereof to a floor portion of the vehicle. The one or more divider panels may be secured in this manner from the interior cabin of the vehicle. The one or more divider panels may be selectively installed in the interior cabin of the vehicle, so that the interior cabin can be configured and separated into compartments as necessary for a particular application. The one or more divider panels may be removed and replaced, from the interior cabin of the vehicle, to reconfigure the arrangement of compartments in the vehicle as necessary for a particular application. The system of divider panels may provide a modular solution to the

The modular nature of the system of divider panels, in accordance with implementations described herein, may provide flexibility in the arrangement, and rearrangement, of divider panels to define compartments and/or segregate/isolate areas within the interior cabin of the vehicle as necessary for a particular application. The coupling, or securing, or mounting of the divider panels at mounting points provided in the roof portion of the vehicle may allow the removal and replacement of divider panels to be accomplished without extensive removal and replacement of other interior components of the vehicle, and without extensive modification of other interior components of the vehicle, thus facilitating the customization of the interior cabin of the vehicle as necessary for a particular user and/or a particular application of the vehicle.

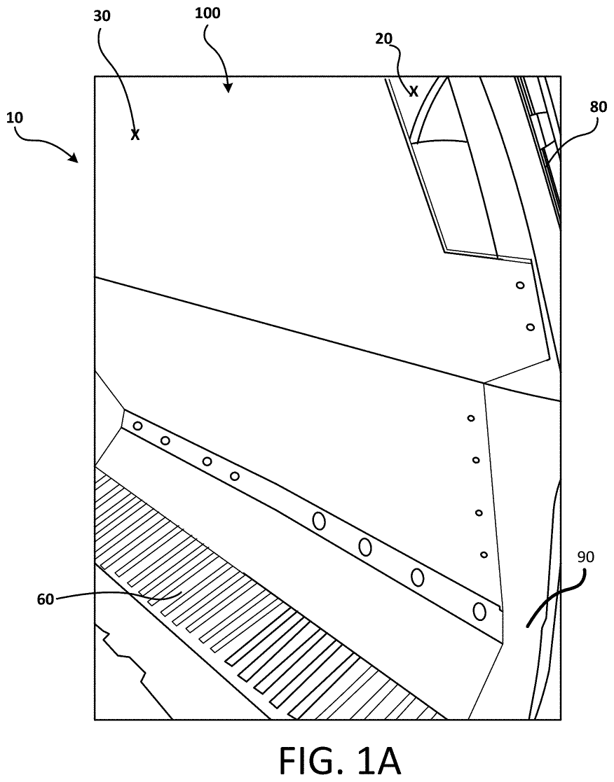

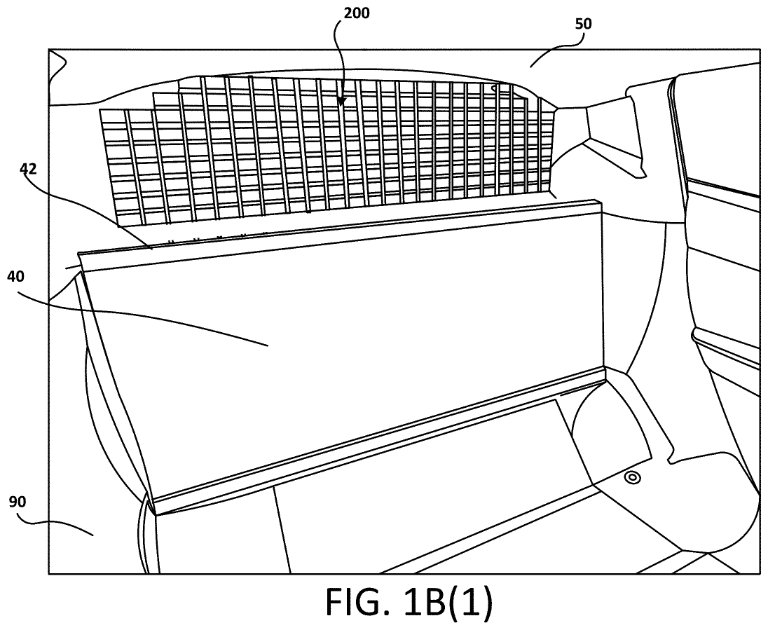

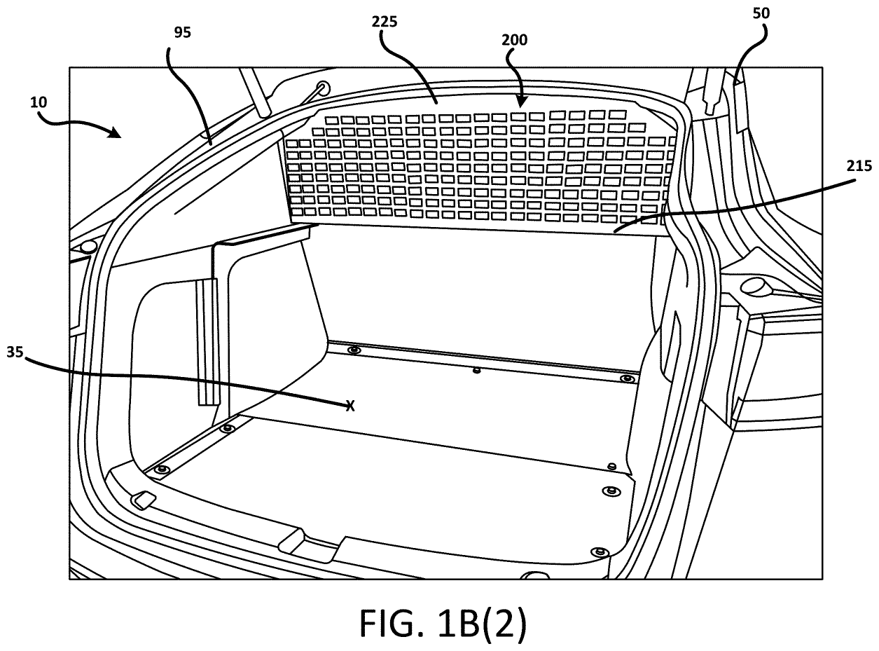

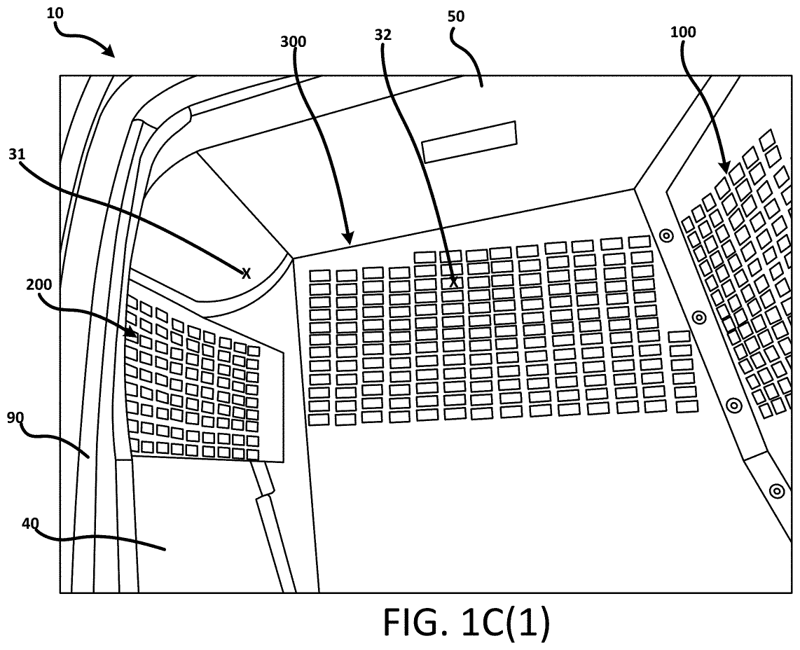

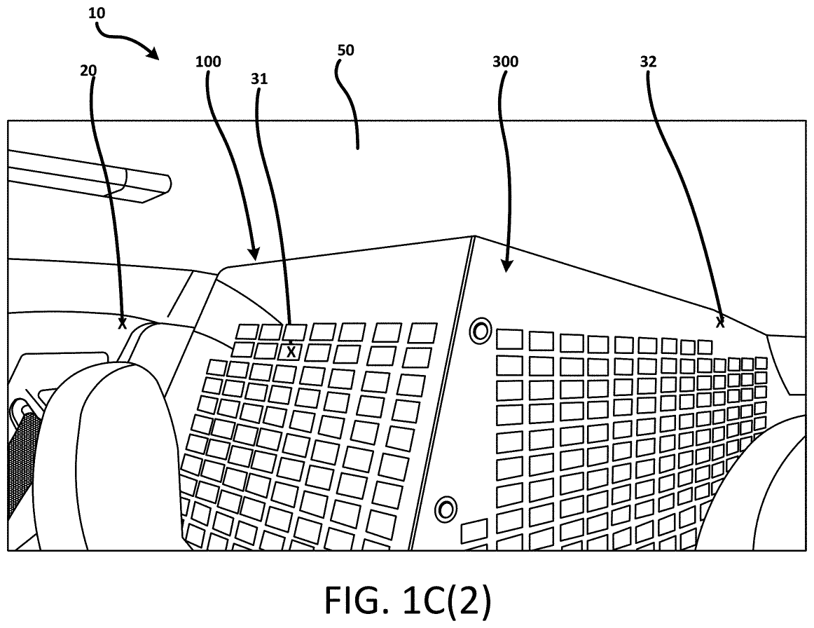

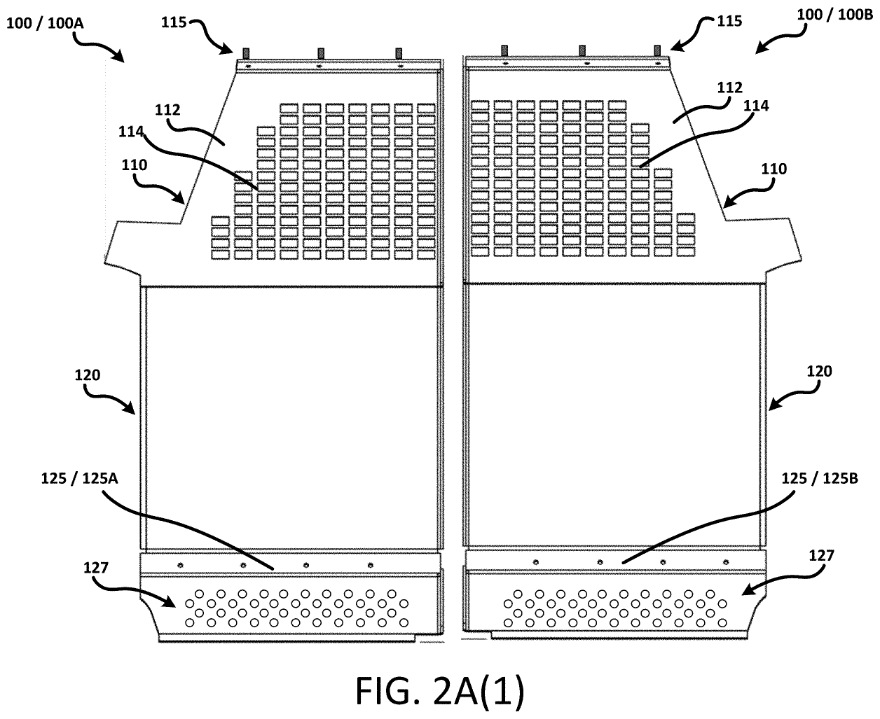

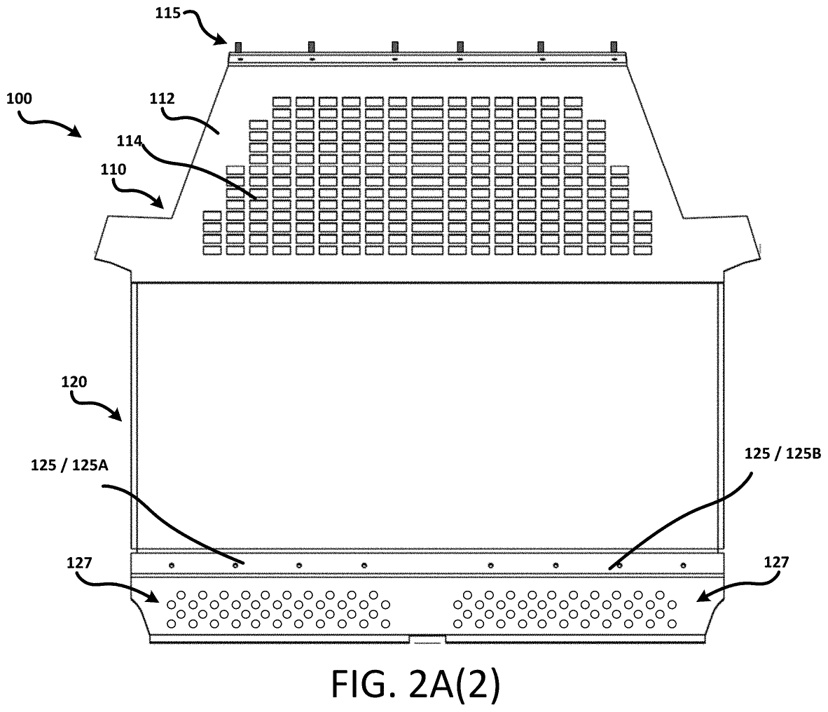

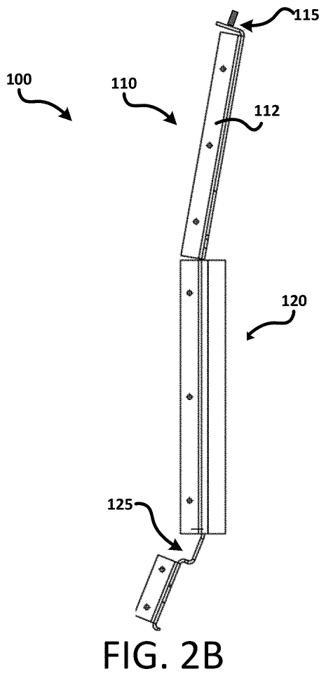

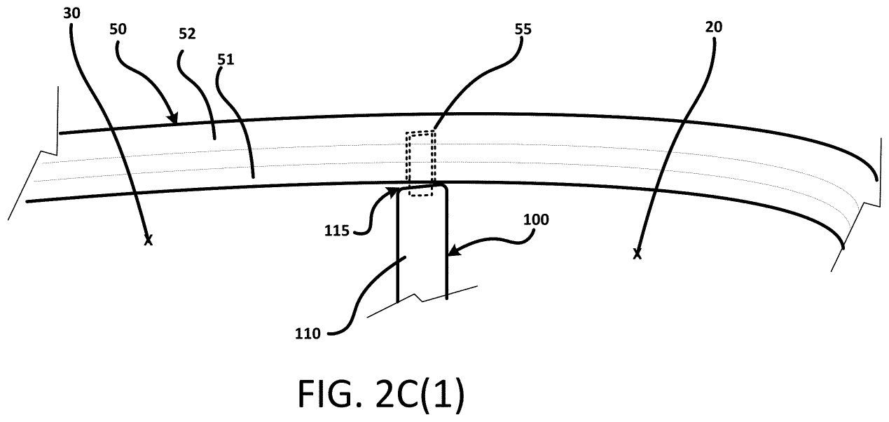

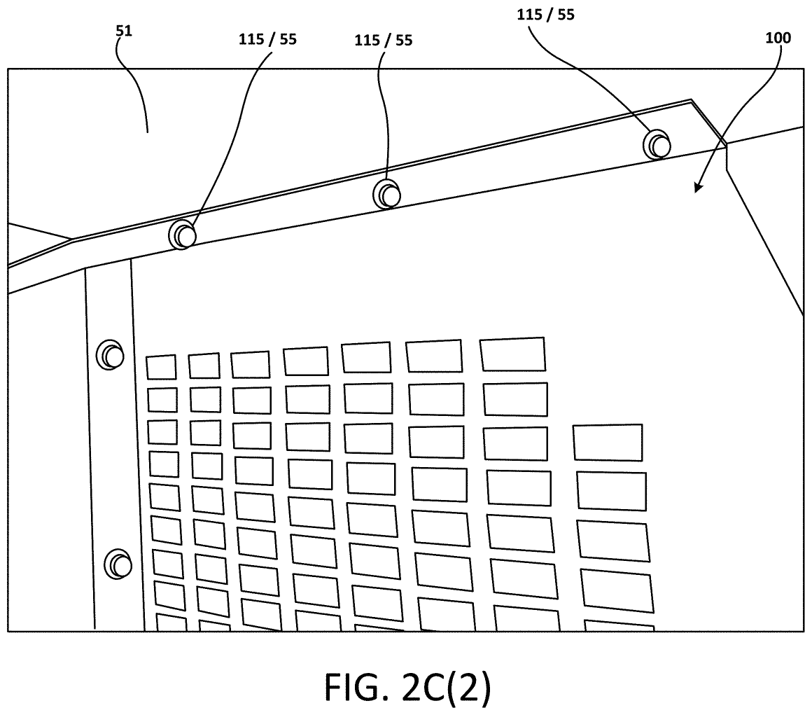

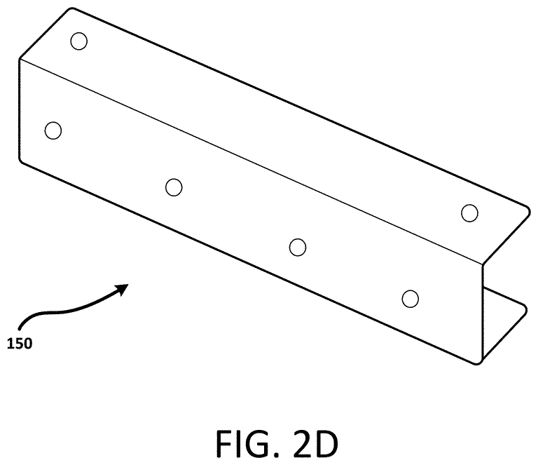

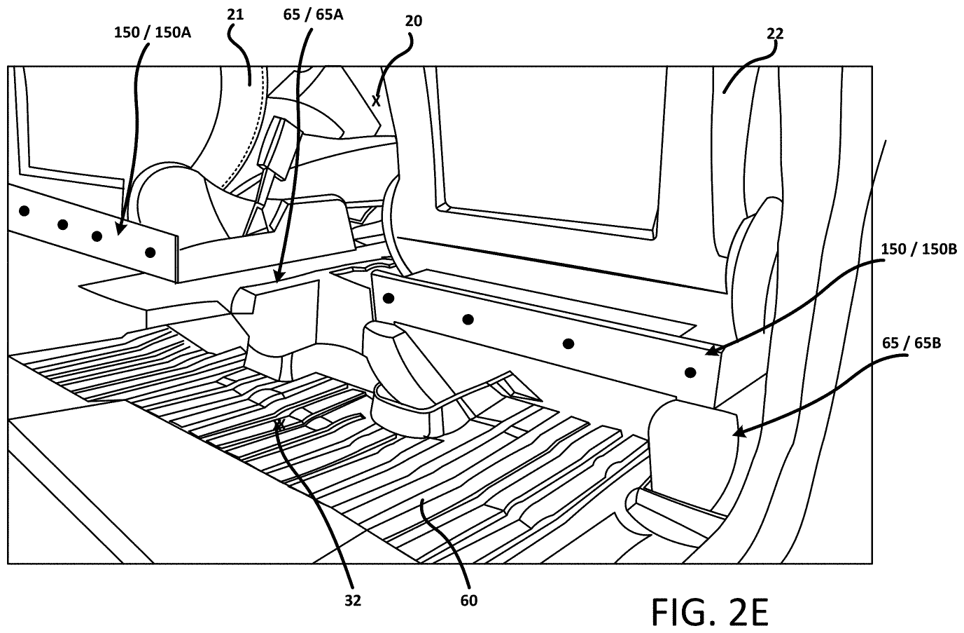

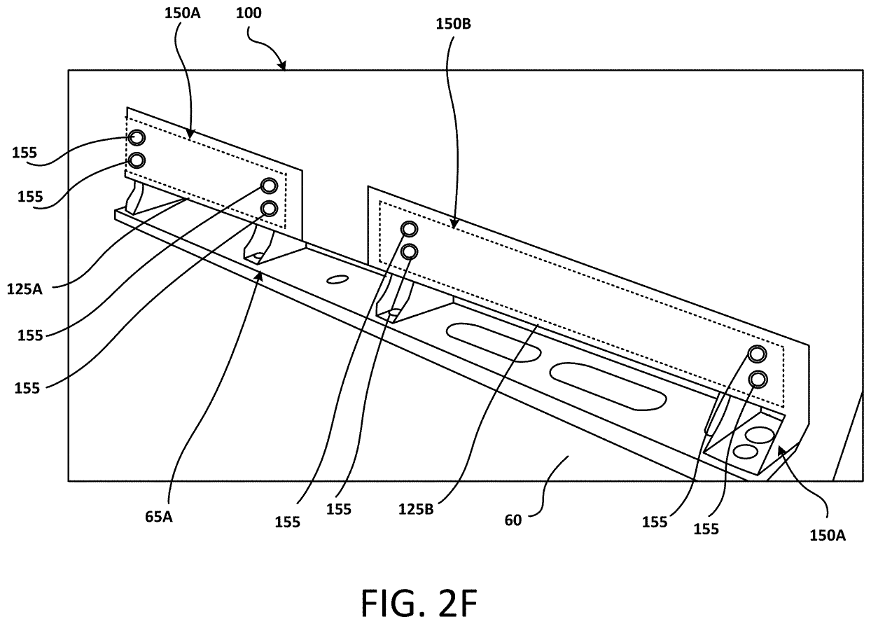

FIG. 1A illustrates installation of an example first divider panel 100 in an example vehicle 10, in accordance with implementations described herein. In the view shown in FIG. 1A, a door (not shown in FIG. 1A) is open relative to a door frame 90 and support pillar 80 of the example vehicle 10, so that a portion of a rear cabin area 30, a portion of a rear seat 40, a portion of a roof 50, a portion of a floor 60 of the vehicle 10, and the installed first divider panel 100 are visible. In the example shown in FIG. 1A, the first divider panel 100 is installed so as to separate the rear cabin area 30 from a front cabin area 20 of the vehicle 10. In particular, the first divider panel 100 may be installed so as to restrict access to the front cabin area 20 from the rear cabin area 30 of the vehicle 10. In the arrangement shown in FIG. 1A, a top portion of the first divider panel 100 is coupled to, or mounted to, or secured to the roof 50 of the vehicle 10. In particular, the top portion of the first divider panel 100 may be secured to an interior portion of the roof 50. In some examples, mounting points provided in the roof 50 may be accessible from the interior cabin of the vehicle 10 to facilitate the mounting or securing of the top portion of the first divider panel 100 to the roof 50. In the arrangement shown in FIG. 1A, a bottom portion of the first divider panel 100 is coupled to, or mounted to, or secured to the floor 60 of the vehicle 10. In particular, the bottom portion of the first divider panel 100 may be secured to the floor 60 via support rail structure 65 supporting front seats 21, 22 (see FIGS. 2D and 2E) installed in the front cabin area 20.

FIGS. 1B(1) and 1B(2) illustrate installation of an example second divider panel 200 in the example vehicle 10, in accordance with implementations described herein. In particular, in FIG. 1B(1) the second divider panel 200 is visible via the door frame 90 of the example vehicle 10. In FIG. 1B(2), a cargo area door (not shown) is open relative to a cargo area frame 95 defining an access opening into a cargo area 35 of the vehicle 10, behind the rear cabin area 30. In the example shown in FIGS. 1B(1) and 1B(2), the second divider panel 200 is installed so as to separate the rear cabin area 30 from the cargo area 35 of the vehicle 10, or restrict access to the cargo area 35 from the rear cabin area 30 of the vehicle 10. In the arrangement shown in FIGS. 1B(1) and 1B(2), a top edge portion of the second divider panel 200 defines a coupling portion 225 that provides for coupling of the top portion of the second divider panel 200 to the vehicle 10. In some examples, the coupling portion 225 may be secured between the cargo area frame 95 and the cargo area door (not shown). In some examples, the top portion of the second divider panel 200 may be coupled to, or mounted to, or secured to an interior portion of the roof 50. In some examples, mounting points provided in the roof 50 may be accessible from the interior cabin of the vehicle 10 to facilitate the mounting or securing of the top portion of the second divider panel 200 to the roof 50. In the arrangement shown in FIGS. 1B(1) and 1B(2), a bottom portion of the second divider panel 200 may define a coupling portion 215 that is coupled to, or mounted to, or secured to a top portion of the rear seat 40 of the vehicle 10. In some examples, the bottom portion of the second divider panel 200 may be secured to a rear portion of an upper ledge portion 42 of the rear seat 40 via, for example, mounting points defined in the rear seat 40.

FIGS. 1C(1) and 1C(2) illustrate installation of an example third divider panel 300 in the example vehicle 10, in accordance with implementations described herein. In the view shown in FIG. 1C(1), a door (not shown in FIG. 1C) is open relative to the door frame 90 and support pillar 80 of the example vehicle 10, and the installation of the third divider panel 300 in the rear cabin area 30 is visible through the access defined by the door frame 90 and support pillar 80. FIG. 1C(2) illustrates the third divider panel 300 as viewed from the front cabin area 20. In the example shown in FIGS. 1C(1) and 1C(2), the third divider panel 300 is installed so as to separate the rear cabin area 30 into a first rear cabin area 31 and a second rear cabin area 32. In particular, installation of the third divider panel 300 may restrict access to the second rear cabin area 32 from the first rear cabin area 31, and may restrict access to the first rear cabin area 31 from the second rear cabin area 32. In this example arrangement, the first rear cabin area 31 and the second rear cabin area 32 are each configured for seating, simply for purposes of discussion an illustration. In some examples, the first rear cabin area 31 and/or the second rear cabin area 32 may be configured or equipped in other manners. For example, in addition to seating, the first rear cabin area 31 and/or the second rear cabin area 32 may be configured for equipment storage and/or transport, canine transport, and the like.

In the arrangement shown in FIGS. 1C(1) and 1C(2), a top portion of the third divider panel 300 is coupled to, or mounted to, or secured to the roof 50 of the vehicle 10. In particular, the top portion of the third divider panel 300 may be secured to an interior portion of the roof 50. In some examples, mounting points provided in the roof 50 may be accessible from the interior cabin of the vehicle 10 to facilitate the mounting or securing of the top portion of the third divider panel 300 to the roof 50. In some examples, a bottom portion of the third divider panel 300 may be coupled to, or mounted to, or secured to the floor 60 of the vehicle 10. In some examples, a rear end portion of the third divider panel 300 and/or an intermediate portion of the third divider panel 300 may be coupled to, or mounted to, or secured to a corresponding portion of the rear seat 40.

FIG. 2A(1) is a plan view of a first configuration of the example first divider panel 100. FIG. 2A(2) is a plan view of a second configuration of the example first divider panel 100. FIG. 2B is a side view of the example first divider panel 100. In particular, FIG. 2A(1) is a plan view in which the example first divider panel 100 includes a first panel 100A and a second panel 100B. FIG. 2A(2) is a plan view in which the example first divider panel 100 is formed as a single panel. As shown in FIGS. 2A(1), 2A(2) and 2B, the first divider panel 100 (including the first panel 100A and the second panel 100B in the implementation shown in FIG. 2A(1) or the single panel shown in FIG. 2A(2)) may include a first section 110 and a second section 120. The first section 110 may include an upper panel 112 supported within a frame 114, with a plurality of first coupling portions 115 arranged on an upper portion of the frame 114. The first coupling portions 115 may be coupled in mounting portions in the roof 50 of the vehicle 10 (to be described below with respect to FIGS. 2C(1) and 2C(2)). The example first coupling portions 115 may include protrusions that are inserted into mounting portions in the roof 50 of the vehicle 10. The first coupling portions 115 of the example first divider panels 100 shown in FIGS. 2A(1) and 2A(2) can include more, or fewer, protrusions, arranged differently than shown in this example. In some examples, fasteners such as bolts may be inserted through openings in the first coupling portions 115 and into the mounting portions in the roof 50 of the vehicle 10, instead of, or in addition to the protrusions.

In some examples, the upper panel 112 may be transparent or translucent, to provide for visibility through the upper panel 112. For example, a transparent or translucent upper panel 112 may provide a driver in the front cabin area 20 with visibility to the rear of the vehicle 10, for example via a rearview mirror. In an example in which the vehicle 10 is equipped for public safety, a transparent or translucent upper panel 112 may allow a public safety officer in the front cabin area 20 to view passengers and/or equipment in the rear cabin area 30. The upper panel 112 may be made of, for example, a polycarbonate material, a mesh material, and other such materials that may provide for overall rigidity of the upper panel 112, alone or together with the frame 114, while also providing for visibility therethrough.

The second section 120 of the first divider panel 100 may be coupled to the frame 114 of the first section 110 or integrally formed with the frame 114 of the first section 110. A plurality of second coupling portions 125 may be arranged along a lower portion of the second section 120. The second coupling portions 125 may provide for the coupling of the second section 120 of the first divider panel 100 to corresponding support structure (to be described below with respect to FIGS. 2D and 2E) at the floor of the vehicle 10. The second section 120 of the first divider panel 100 may be made of a material that provides for overall structural rigidity of the first divider panel 100, such as, for example, a metal material such as aluminum or other such materials.

In some examples, perforations 127 may be formed in a portion of the first divider panel 100. The perforations 127 may provide for airflow into the rear cabin area 30. In the example shown in FIGS. 2A(1) and 2A(2), the perforations 127 are formed in a lower portion of the second section 120 of the first divider panel 100, corresponding to an area under the seats 21, 22 in the front cabin area 20. In some arrangements, ducting of a heating, ventilation and air conditioning system of the vehicle 10 may provide airflow from under the seats 21 and/or 22, through the perforations 127, and into the rear cabin area 30. In some examples, perforations 127 may be formed in the first divider panel 100 at a position corresponding a console positioned between the seats 21, 22 in the front cabin area 20, to provide airflow into the rear cabin area 30. The material of the frame 114 and the upper panel 112 of the first section 110, together with the material of the second section 120, may provide for a level or amount or degree of structural rigidity that allows the first divider panel 100 to be stably mounted or installed in the vehicle 10 by the first coupling portions 115 at the top portion of the first divider panel 100 and the second coupling portions 125 at the bottom portion of the first divider panel 100. In some examples, the first divider panel 100 may be stably mounted in the vehicle 10 without additional coupling support at the opposite lateral ends thereof, which would require disassembly, reconfiguration and the like of the corresponding support pillars 80 at the interior sides of the vehicle 10. The mounting of the first divider panel 100 will be described in more detail below with respect to FIGS. 2C(1) through 2F.

FIG. 2C(1) is a side view, and FIG. 2C(2) is a perspective view, of an example coupling of the first coupling portion(s) 115 of the first divider panel 100 to the roof 50 of the vehicle 10, in accordance with implementations described herein. As shown in FIGS. 2C(1) and 2C(2), the roof 50 may include an interior panel 51 coupled to an exterior panel 52. The interior panel 51 may define an interior roof surface of the interior cabin of the vehicle 10. The roof 50 may include a plurality of mounting points 55. Various components, accessories and the like may be selectively mounted to the roof 50 via the mounting points 55. FIG. 2C(1) illustrates one of a plurality of mounting points 55 that may be formed in the roof 50. In the example shown in FIG. 2C(1), the example mounting point 55 extends through the interior panel 51 and into the exterior panel 52. FIG. 2C(1) illustrates one of the plurality of first coupling portions 115 of the first divider panel 100 received in, or coupled in, or mounted in, or installed in the mounting point 55. Mounting of the first coupling portions 115 of the first divider panel 100 into corresponding mounting points 55 defined in the roof 50 (i.e., by the protrusions inserted into the mounting points 55, fasteners inserted through the first coupling portions 115 and into the mounting points 55 and/or a combination thereof) may provide structural support at the top portion of the first divider panel 100 for mounting of the first divider panel 100 in the interior cabin of the vehicle 10. In some examples, the protrusions of the first coupling portions 115 may be slidably received in, or press fit into the corresponding mounting points 55. In some examples, the first coupling portions 115 secured to the corresponding mounting points 55 in other ways.

FIG. 2D illustrates a bracket 150 which can be fixed to support structure at the floor 60 of the vehicle 10 to couple, or secure, the bottom portion of the first divider panel 100 to the vehicle 10. FIG. 2E illustrates the bracket 150 fixed to a support rail structure 65 which is in turn fixed to the floor 60 the vehicle 10. FIG. 2F illustrates a bottom portion of the first divider panel 100 fixed to the support rail structure 65 via the bracket 150. The support rail structure 65 may be structure that is already in place in the vehicle 10 to support the installation of the front seats in the front cabin area 20 of the vehicle 10. Thus, the mounting of the support bracket 150 to the existing support rail structure 65, and the mounting of the bottom portion of the first divider panel 100 to the support bracket 150 may be accomplished making use of existing structural components in the vehicle 10, and without removal and/or replacement and/or reconfiguration of existing structure.

In the example arrangement shown in FIG. 2E, a first bracket 150A is fixed to a first support rail structure 65A supporting a first seat 21 in the front cabin area 20 of the vehicle 10, and a second bracket 150B is fixed to a second support rail structure 65B supporting a second seat 22 in the front cabin area 20 of the vehicle 10. In the example arrangement shown in FIG. 2F, the second coupling portion 125A of the second section 120 of the first divider panel 100 is then coupled to the first bracket 150A fixed to the first support rail structure 65A, and the second coupling portion 125B of the second section 120 of the first divider panel 100 is coupled to the second bracket 150B fixed to the second support rail structure 65B.

In one example installation procedure, the brackets 150 (the first bracket 150A and the second bracket 150B in the example shown in FIGS. 2D-2F) may be installed on the corresponding rail structure 65 (the first rail structure 65A and the second rail structure 65B in the example shown in FIGS. 2D-2F) of the vehicle 10. The first coupling portions 115 of the first divider panel 100 may be inserted into and secured in the corresponding mounting points 55 in the roof 50. With the first coupling portions 115 of the first divider panel 100 received in the respective mounting points 55 in the roof 50, the bottom portion of the second section 120 of the first divider panel 100 may then be positioned in place against the brackets 150 installed on the support rail structures 65, i.e., with the coupling portion 125A positioned against the first bracket 150A installed on the first support rail structure 65A, and the coupling portion 125B positioned against the second bracket 150B installed on the second support rail structure 65B. With the coupling portions 125A, 125B at the bottom portion of first divider panel 100 aligned with the brackets 150A, 150B in this manner, fasteners 155 may be inserted through the coupling portions 125A, 125B and into the brackets 150A, 150B to fix the bottom portion of the first divider panel 100 to the rail structure 65A, 65B, which is in turn fixed to the floor 60 of the vehicle 10.

Attachment, or mounting, or coupling, or securing of the top portion of the first divider panel 100 and the bottom portion of the first divider panel 100 to existing structure of the vehicle 10 in the manner described above may allow the first divider panel 100 to be secured in place in the vehicle 10. Installation of the first divider panel 100 in this manner may be accomplished without removal and/or replacement of existing components, without reconfiguration and/or destruction of existing structure, and the like. In general, installation of existing/known divider/barrier systems into a vehicle typically involve the time consuming and costly removal, reconfiguration, reconstruction and the like of the various components of the lateral support pillars 80 of the vehicle 10. In contrast, the ability to mount the first divider panel 100 to structural components of the roof 50 and to structural components of the floor 60 of the vehicle 10, in accordance with implementations described herein, may allow the first divider panel 100 to be securely and stably mounted to existing vehicle structure, without destruction and reconstruction of the side support pillars 80. Thus, the first divider panel 100 installed in this manner may extend from the roof 50 to the floor 60 of the vehicle 10, and between opposite lateral side portions of the interior cabin area to the support pillars 80. The first divider panel 100 may be supported in this position through the securing or coupling provided at the roof 50 and the floor 60 of the vehicle 10, independently from the side support pillars 80 at the opposite lateral side portions of the interior cabin area. The support provided at the top portion and the bottom portion of the first divider panel 100 installed in this manner may obviate the need for securing side portions of the first divider panel 100 to the side support pillars 80 at the opposite lateral side portions of the interior cabin area of the vehicle 10, which would otherwise involve disassembly, reconfiguration, reassembly and the like of the side support pillars 80.

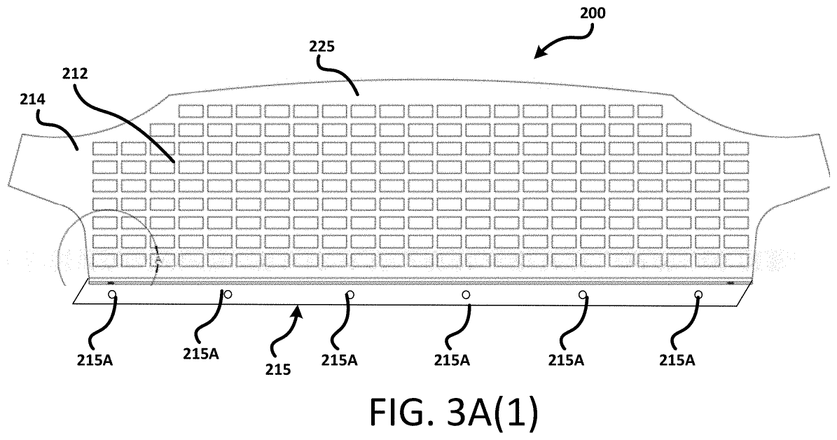

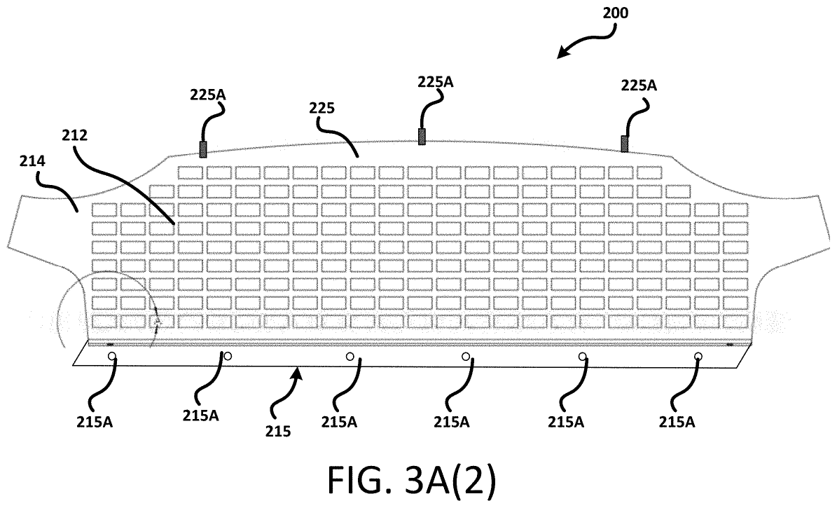

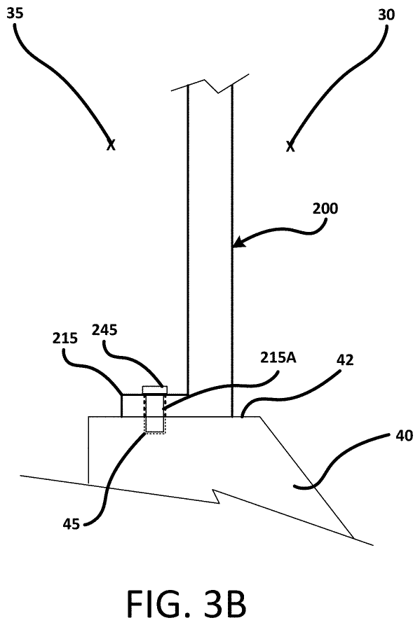

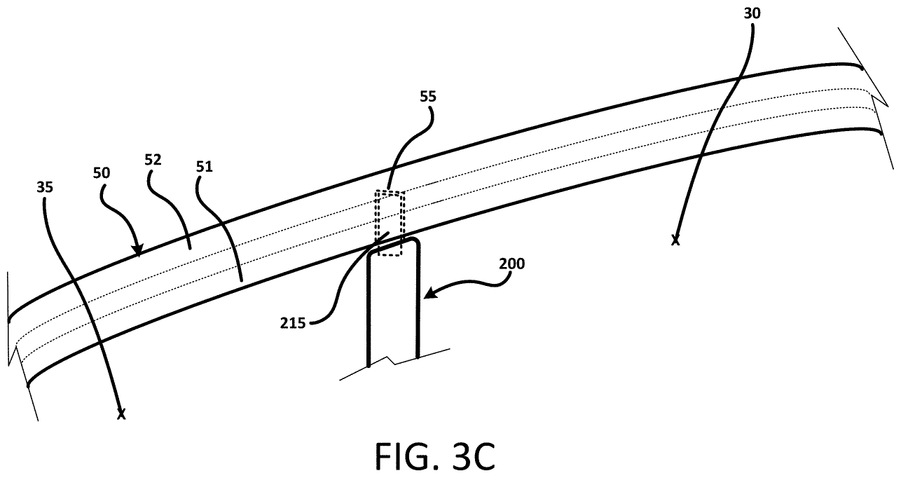

FIG. 3A(1) is a rear view of a first configuration of the example second divider panel 200, in accordance with implementations described herein. FIG. 3A(2) is a rear view of a second configuration of the example second divider panel 200, in accordance with implementations described herein. The second divider panel 200 may include a panel 212 supported within a frame 214. A first coupling portion 215 at a lower portion of the second divider panel 200 may include one or more openings 215A. The first coupling portion 215 and openings 215A may provide for the coupling of the second divider panel 200 to corresponding support structure such as, for example support structure associated with the rear seat 40 of the vehicle 10. In the example shown in FIG. 3A(1), the second divider panel may include a second coupling portion 225 at an upper end portion of the panel 212. In the example shown in FIG. 3A(1), the second coupling portion 225 may be defined by an upper portion of the frame 214 of the second divider panel 200, which may be secured between the cargo area frame 95 and a corresponding portion of a cargo area door positioned against the cargo area frame 95 in a closed position of the cargo area door, such that the second coupling portion 225 is secured between the cargo area frame 95 and the cargo area door.

In the example shown in FIG. 3A(2), the example second divider panel 200 includes one or more protrusions 225A arranged on an upper portion of the frame 214 corresponding to the second coupling portion 225. The one or more protrusions 225A may be coupled in mounting portions in the roof 50 of the vehicle 10 (to be described below with respect to FIG. 3B). The example shown in FIG. 3A(2) includes three protrusions 225A, simply for purposes of discussion and illustration. The second divider panel 200 can include more, or fewer, protrusions 225A, arranged differently than shown in this example.

In some examples, the panel 212 may be transparent or translucent, to provide for visibility through the panel 212. For example, a transparent or translucent panel 212 may provide a driver in the front cabin area 20 with visibility to the rear of the vehicle 10, for example via a rearview mirror. The panel 212 may be made of, for example, a polycarbonate material, a mesh material, and other such materials that may provide for overall rigidity of the panel 212, alone or together with the frame 214, while also providing for visibility therethrough.

The material of the frame 214 and the panel 212 of the second divider panel 200 may provide for a level or amount or degree of structural rigidity that allows the second divider panel 200 to be stably mounted or installed in the vehicle 10 by the first coupling portion 215 at the lower portion of the second divider panel 200 and the second coupling portion 225 at the upper portion of the second divider panel 200. In some examples, the second divider panel 200 may be stably mounted in the vehicle 10 without additional coupling support at the opposite lateral ends thereof, which would require disassembly, reconfiguration and the like of corresponding support portions of the cargo area frame 95 of the vehicle 10.

As shown in FIG. 3B, a plurality of mounting points 45 may be defined in the ledge portion 42 of the rear seat 40. One or more of the plurality of mounting points 45 defined in the ledge portion 42 of the rear seat 40 may correspond to, or be aligned with the one or more openings 215A in the first coupling portion 215 at the lower portion of the second divider panel 200. In one example installation procedure associated with the example second divider panel 200 shown in FIG. 3A(1), with the cargo area door in an open position relative to the cargo area frame 95, the first coupling portion 215 may be positioned on the ledge portion 42 of the rear seat 40, and the second coupling portion 225 may be positioned against the cargo area frame 95. The cargo area door may be closed to secure the second coupling portion between the cargo area door and the cargo area frame 95. With the one or more openings 215A of the first coupling portion 215 aligned with the mounting points 45 defined in the ledge portion 42 of the rear seat 40, fasteners 245 may be inserted through the openings 215A in the first coupling portion 215 and into the mounting points 45 in the ledge portion 42 of the rear seat 40, to fix the bottom portion of the second divider panel 200 to the support structure of the rear seat 40.

FIG. 3C illustrates one of the example protrusions 225A of the second coupling portion 225 of the example divider panel 200 shown in FIG. 3A(2), received in, or coupled in, or mounted in, an example mounting point 55 formed in the roof 50 of the example vehicle 10, the example mounting point 55 extending through the interior panel 51 and into the exterior panel 52 of the roof 50. Mounting of the protrusions 225A of the second coupling portion 225 of the second divider panel 200 shown in FIG. 3A(2) into corresponding mounting points 55 defined in the roof 50 may provide structural support at the upper portion of the second divider panel 200 for mounting of the second divider panel 200 in the interior cabin of the vehicle 10. In some examples, the protrusions 225A may be slidably received in, or press fit into the corresponding mounting points 55. In some examples, the protrusions 225A may be received in and/or secured in the corresponding mounting points 55 in other ways.

In another example installation procedure associated with the example second divider panel 200 shown in FIG. 3A(2), the protrusions 225A of the second divider panel 200 may be inserted into and secured in the corresponding mounting points 55 in the roof 50. With the protrusions 225A of the second divider panel 200 received in the respective mounting points 55 in the roof 50, the lower portion of the second divider panel 200 may then be positioned in place against the ledge portion 42 of the rear seat 40, with the openings 215A in the first coupling portion 215 aligned with the mounting points 45 defined in the ledge portion 42 of the rear seat 40. Fasteners 245 may be inserted through the openings 215A and into the mounting points 45 in the ledge portion 42 of the rear seat 40, to fix the lower portion of the second divider panel 200 to the support structure of the rear seat 40, as shown in FIG. 3B.

Attachment, or mounting, or coupling, or securing of the top portion of the second divider panel 200 and the bottom portion of the second divider panel 200 to existing structure of the vehicle 10 in the manner described above may allow the second divider panel 200 to be secured in place in the vehicle 10. Installation of the second divider panel 200 in this manner may be accomplished without removal and/or replacement of existing components, without reconfiguration and/or destruction of existing structure, and the like. The ability to mount the second divider panel 200 to structural components of the roof 50 and to structural components associated with the rear seat 40, in accordance with implementations described herein, may allow the second divider panel 200 to be securely and stably mounted to existing vehicle structure.

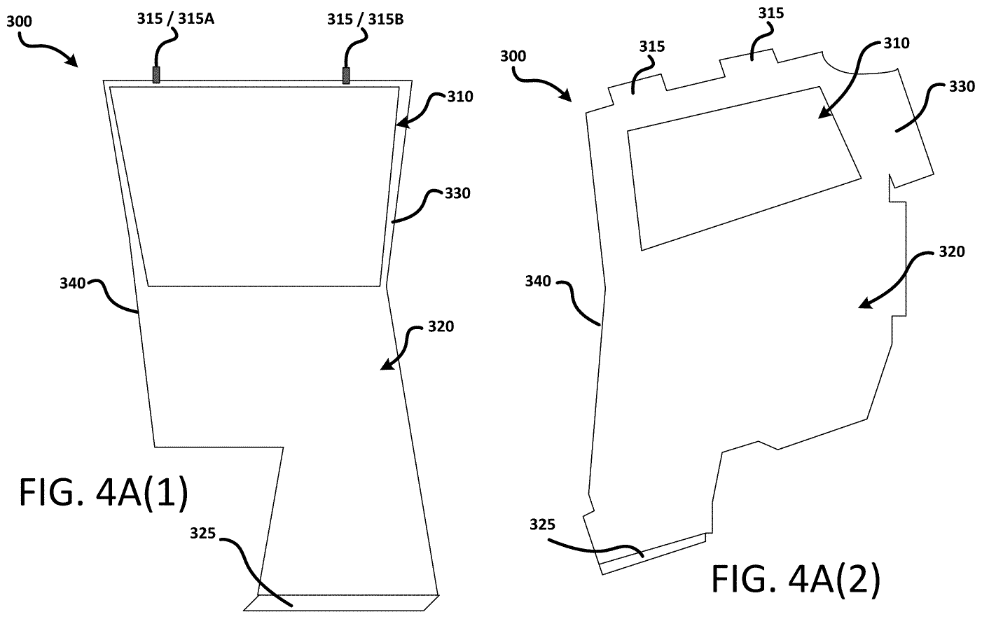

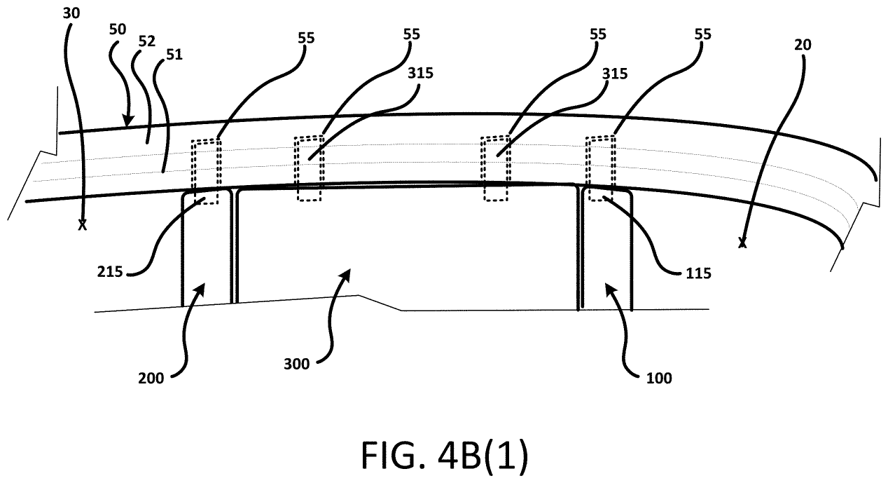

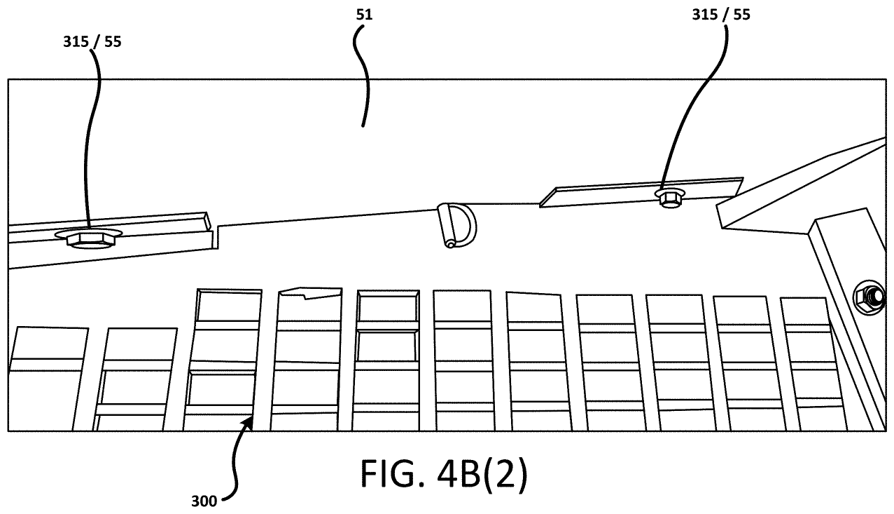

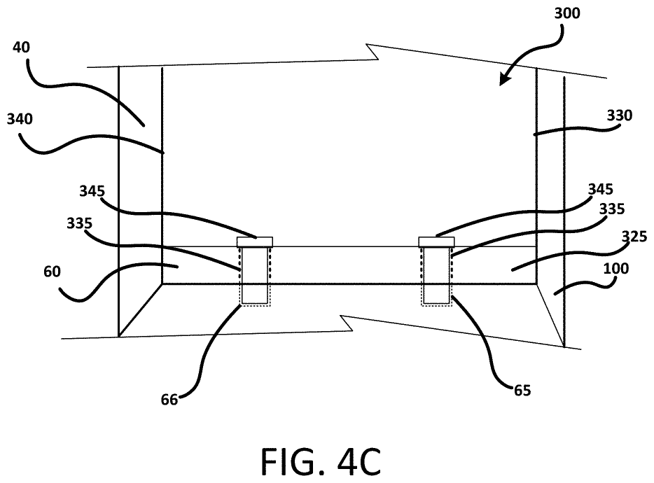

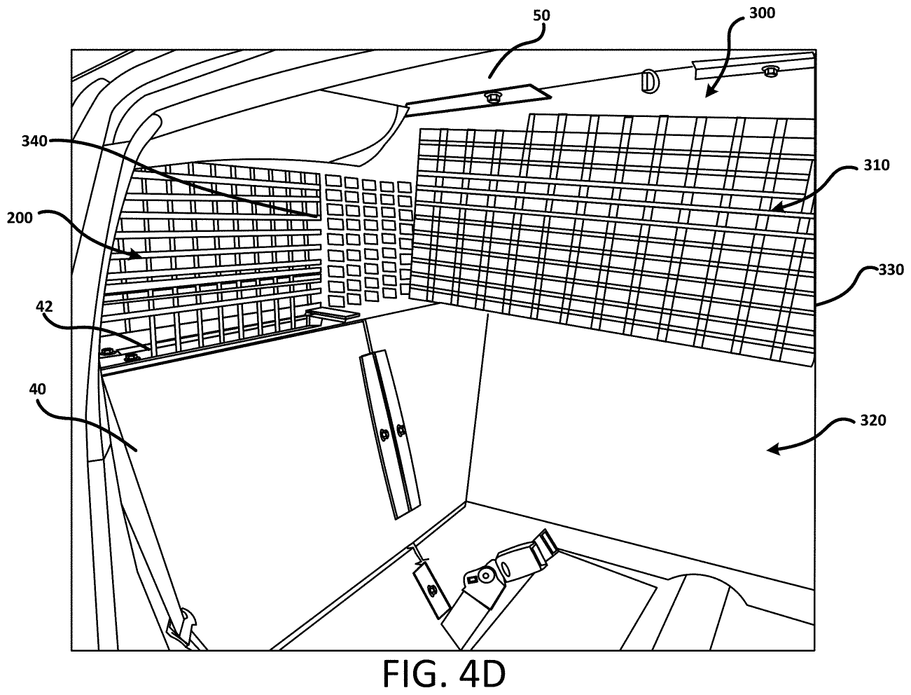

FIG. 4A(1) is a plan view of one configuration of the example third divider panel 300. FIG. 4A(2) is a plan view of another configuration of the example second divider panel. In some implementations, the third divider panel 300 may be defined by a single panel of material that extends from a top portion to a bottom portion of the third divider panel 300. In some implementations, the third divider panel 300 may include a first section 310 coupled to a second section 320. In some implementations, the first section may be transparent, or translucent, to provide for visibility therethrough. As described above, the third divider panel 300 may be installed in the rear cabin area 30, and extend between the first divider panel 100 and the second divider panel 200 (if installed) and/or between the first divider panel 100 and a rear wall (not shown) of the rear cabin area 30, to divide the rear cabin area 30 into the first rear cabin area 31 and the second rear cabin area 32. FIGS. 4B(1) and 4B(2) illustrate the coupling of the example divider panel 300 at the roof 50 of the example vehicle 10, between the example first divider panel 100 and the example second divider panel 200.

In some examples, at least a portion of the first section 310 of the third divider panel 300 may be transparent or translucent, to provide for visibility therethrough. The third divider panel 300 (including a single section or the first and second sections 310, 320) may be made of material(s) that provide for overall rigidity of the third divider panel 300.

In the example shown in FIG. 4A(1), a plurality of first coupling portions 315 are arranged on an upper portion of the third divider panel 300. The first coupling portions 315 may be coupled in corresponding mounting points defined in the roof 50 of the vehicle 10. The example shown in FIG. 4A(1) includes two first coupling portions 315A and 315B, simply for purposes of discussion and illustration. In the example shown in FIG. 4A(1), the first coupling portions 315 are formed as protrusions that can be inserted into corresponding mounting points defined in the roof 50. In the example shown in FIG. 4A(2), the first coupling portions 315 are formed as tabs, including openings through which fasteners may be inserted to couple the upper end portion of the third divider panel 300 to the roof 50 of the vehicle 10. The third divider panel 300 can include more, or fewer, first coupling portions 315, arranged differently than shown in this example. A plurality of second coupling portions 325 may be arranged along a lower portion of the third divider panel 300. The second coupling portions 325 may provide for the coupling of the third divider panel 300 to corresponding support structure at the floor 60 of the vehicle 10.

The material of the third divider panel 300 may provide for a level or amount or degree of structural rigidity that allows the third divider panel 300 to be stably mounted or installed in the vehicle 10 by the first coupling portions 315 at the top portion of the third divider panel 300 and the second coupling portions 325 at the bottom portion of the third divider panel 300. In some examples, the first divider panel 100 may be stably mounted in the vehicle 10 without additional coupling support at the opposite lateral ends thereof. In some implementations, the third divider panel 300 may be coupled at a front end portion 330 thereof to the first divider panel 100 and/or at a rear end portion 340 thereof to the second divider panel 200 and/or to a corresponding portion of the rear seat 40.

As shown in FIG. 4C, a plurality of mounting points 66 may be defined in the floor 60, at positions corresponding to openings 335 in the second coupling portion 325 of the third divider panel 300. In one example installation procedure, the first coupling portions 315 of the third divider panel 300 may be inserted into and secured in the corresponding mounting points 55 in the roof 50. With the first coupling portions 315 of the third divider panel 300 received in the respective mounting points 55 in the roof 50, the bottom portion of the third divider panel 300 may then be positioned in place against the floor, with the openings 335 in the second coupling portion 325 aligned with the mounting points 66 defined in the floor 60. Fasteners 345 may be inserted through the openings 335 and into the mounting points 66 in the floor 60, to fix the bottom portion of the third divider panel 300 to the floor 60. FIG. 4D illustrates the third divider panel 300 installed in the rear cabin area 30 of the example vehicle 10. Installation of the third divider panel 300 in this manner may be accomplished without removal and/or replacement of existing components, without reconfiguration and/or destruction of existing structure, and the like. The ability to mount the third divider panel 300 to structural components of the roof 50 and to structural components associated with the floor 60, in accordance with implementations described herein, may allow the third divider panel 300 to be securely and stably mounted to existing vehicle structure.

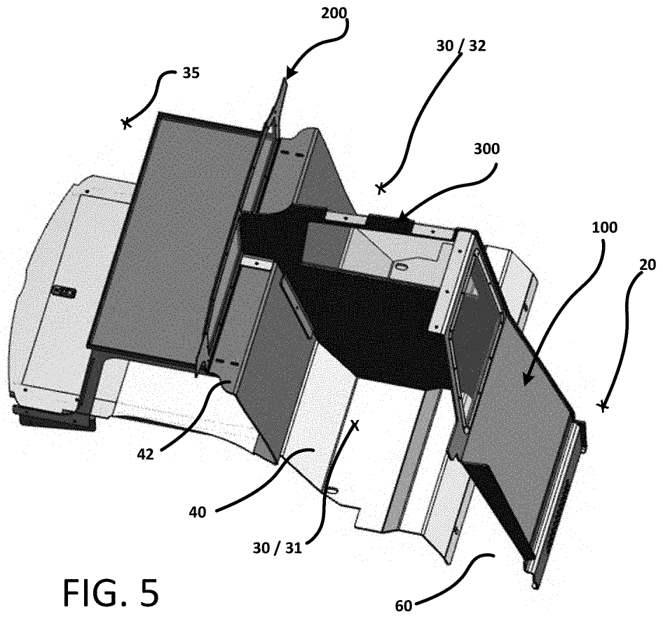

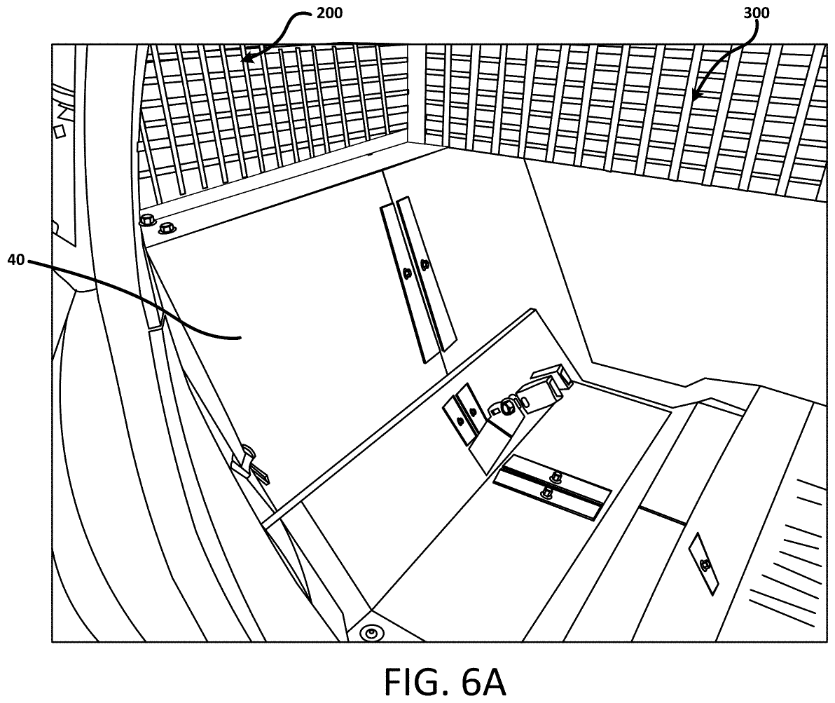

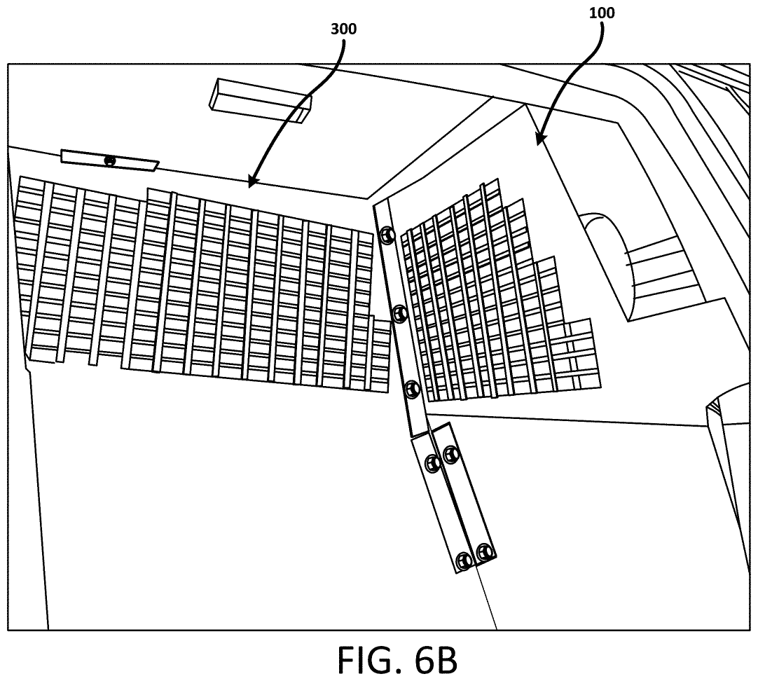

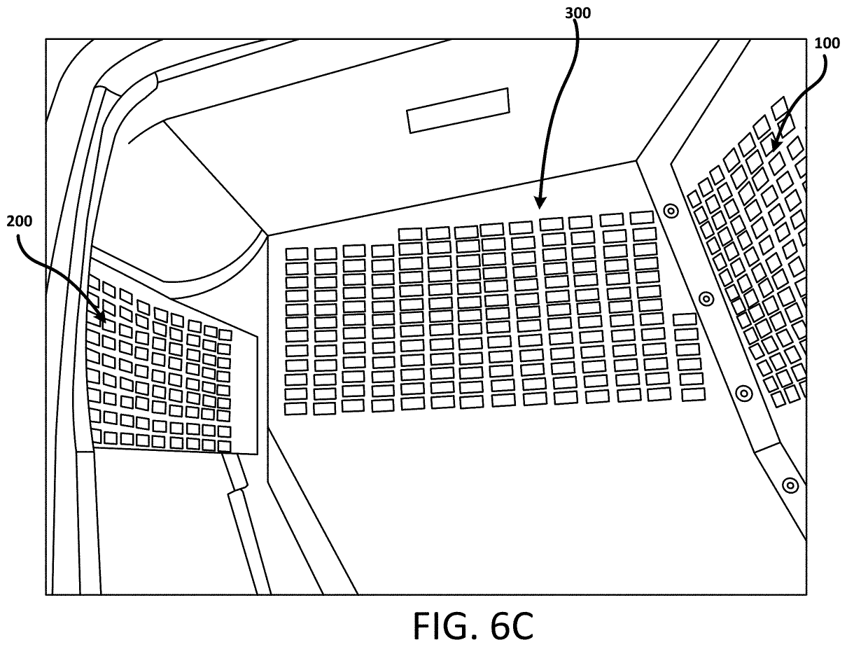

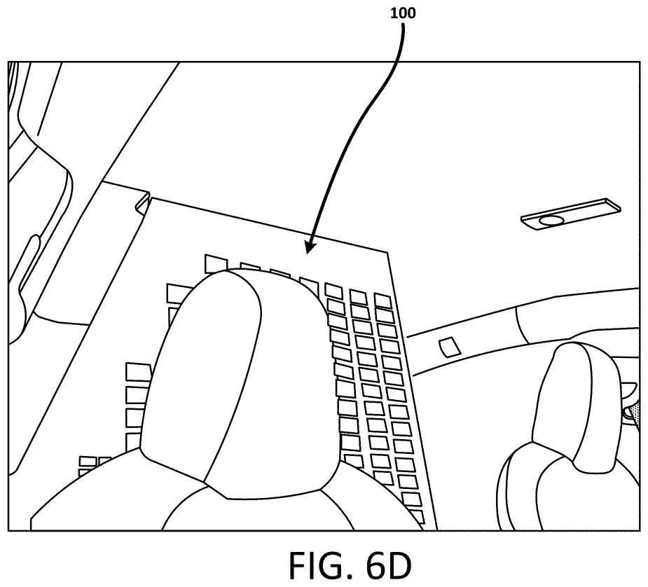

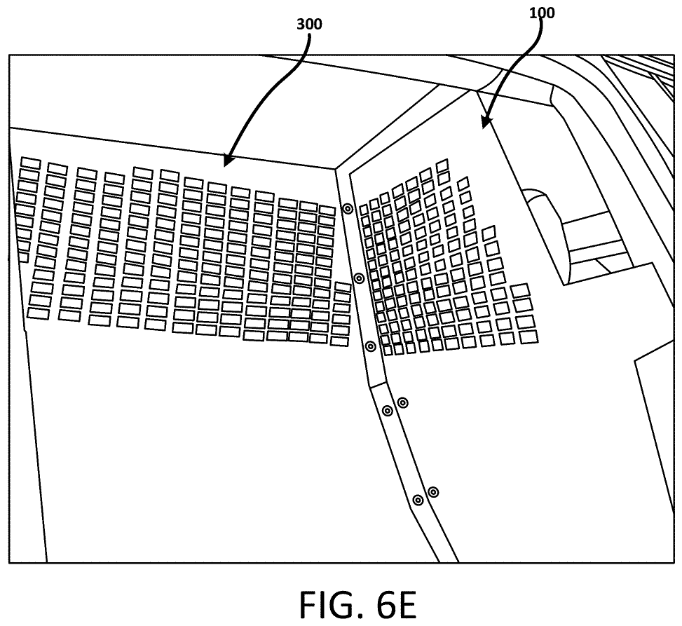

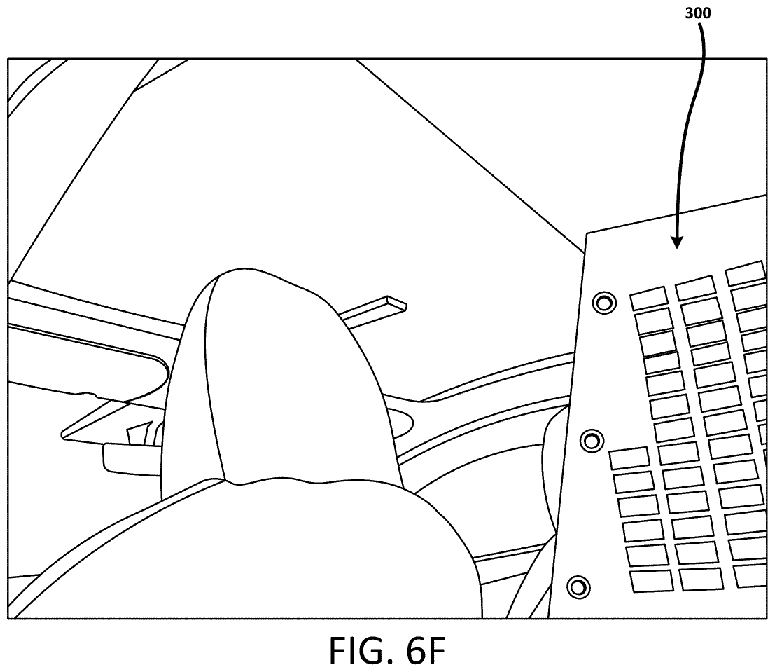

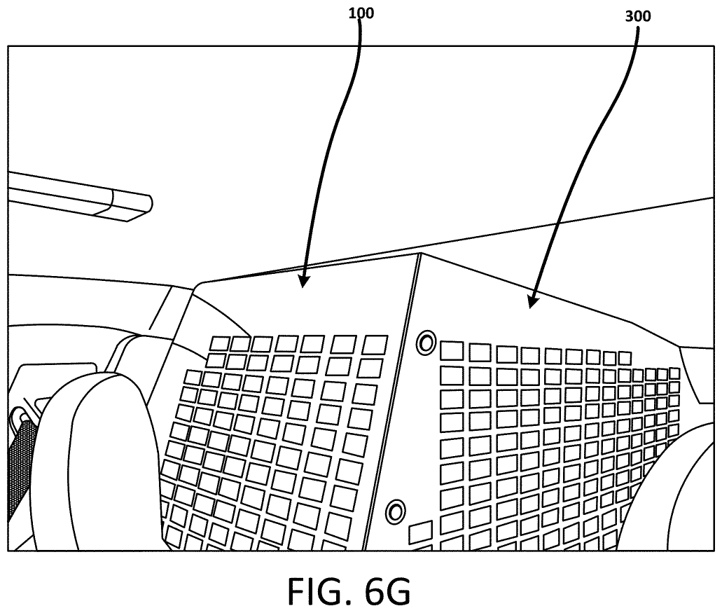

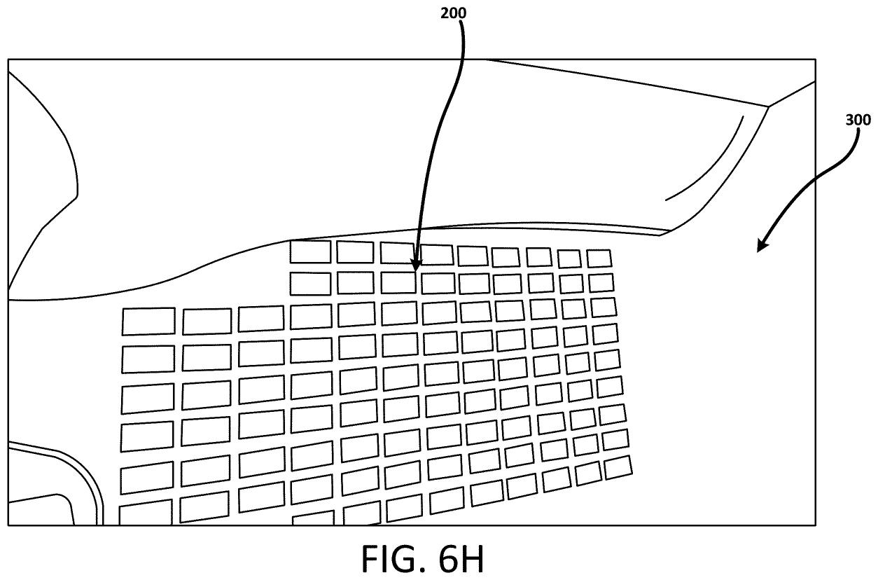

FIG. 5 is a top perspective view of the example vehicle 10, with the roof 50 removed, so that the interior cabin is visible. FIGS. 6A through 6H provide various additional views of the example divider panel system including the example first divider panel 100, the example second divider panel 200, and the example third divider panel 300 installed in the example vehicle 10. In the example arrangement shown in FIG. 5A, the first divider panel 100 and the second divider panel 200 are installed in the interior cabin, as described above. In the example arrangement shown in FIG. 5, the front cabin area 20 and the cargo area 35 are inaccessible from the rear cabin area 30, with access between the first rear cabin area 31 and the second rear cabin area 32 prohibited by the third divider panel 300. The example arrangement and combinations of the configurations of the first, second and third divider panels 100, 200, 300 is presented in FIG. 5 simply for purposes of discussion and illustration. Other example arrangements and/or combinations of the configurations of the first, second and third divider panels 100, 200, 300 may also be installed in the example vehicle 10.

The modular design and installation alternatives afforded by the plurality of dividers and plurality of mounting points provided throughout the vehicle allow the vehicle to be configured, and re-configured quickly and easily for a variety of different uses and applications. The configuration and re-configuration of the vehicle can be accomplished without removal and/or replacement of additional components, destruction of existing components, structure and the like, provide a cost-effective solution to providing vehicles customized for specific uses and applications.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A divider system for a vehicle, comprising:
a first divider panel configured to be removably coupled in a first portion of an interior cabin of a vehicle, wherein the first divider panel extends between a roof portion and a floor portion of the vehicle, and between a first lateral side portion and a second lateral side portion of the vehicle, to separate a first cabin area and a second cabin area of the interior cabin of the vehicle, the first divider panel including:
a first panel section defining an upper portion of the first divider panel;
a second panel section coupled to the first panel section and defining a lower portion of the first divider panel;
a first coupling portion provided at an upper end portion of the first panel section, including a plurality of protrusions configured to be removably received in corresponding mounting points formed in the roof portion of the vehicle; and
a second coupling portion provided at a lower end portion of the second panel section, including a plurality of openings configured to provide for removable coupling of the lower end portion of the second panel section to the floor portion of the vehicle,
wherein the first divider panel is configured to be supported in the interior cabin of the vehicle via the coupling of the first panel section to the roof portion and the second panel section to the floor portion of the vehicle, independent of a first support pillar and a second support pillar respectively provided at the first lateral side portion and the second lateral side portion of the vehicle.

2. The divider system of claim 1, further comprising at least one bracket coupled to a corresponding rail structure fixed to the floor portion of the vehicle, wherein the second coupling portion of the first divider panel is configured to be removably coupled to the rail structure via the at least one bracket.

3. The divider system of claim 2, wherein the at least one bracket includes:
a first bracket coupled to a first rail structure supporting a first seat in the first cabin area; and
a second bracket coupled to a second rail structure supporting a second seat in the first cabin area.

4. The divider system of claim 3, wherein a plurality of fasteners extend through the plurality of openings in the second coupling portion of the first divider panel and into the first bracket and the second bracket to removably couple the lower portion of the first divider panel to the floor portion of the vehicle.

5. The divider system of claim 1, wherein the first panel section of the first divider panel includes a rigid frame surrounding a rigid material that is at least partially transparent.

6. The divider system of claim 1, further comprising a second divider panel configured to divide the second cabin area from a third cabin area of the interior cabin of the vehicle, the second divider panel including:
a third coupling portion provided at an upper end portion of the second divider panel and configured to be removably coupled to the roof portion of the vehicle; and
a fourth coupling portion provided at a lower end portion of the second divider panel and configured to be removably coupled to corresponding mounting points provided in a rear seat support structure of the vehicle.

7. The divider system of claim 6, wherein the third coupling portion is configured to be removably secured between a frame portion of the third cabin area and a door of the third cabin area.

8. The divider system of claim 6, wherein the third coupling portion includes a plurality of protrusions configured to be removably received in corresponding mounting points formed in the roof portion of the vehicle.

9. The divider system of claim 6, wherein the second divider panel includes a rigid frame surrounding a rigid material that is at least partially transparent.

10. The divider system of claim 6, further comprising a third divider panel configured to divide the second cabin area into a first section and a second section, the third divider panel including:
a fifth coupling portion provided at an upper end portion of the third divider panel, including a plurality of protrusions configured to be removably received in corresponding mounting points formed in the roof portion of the vehicle; and
a sixth coupling portion provided at a lower end portion of the third divider panel and configured to removably couple the lower end portion of the third divider panel to the floor portion of the vehicle.

11. The divider system of claim 10, further comprising at least one fastener extending through at least one corresponding opening in the sixth coupling portion and into at least one corresponding mounting point in the floor portion of the vehicle to removably couple the lower end portion of the third divider panel to the floor portion of the vehicle.

12. The divider system of claim 10, further comprising a seventh coupling portion at a rear end portion of the third divider panel and configured to removably couple the rear end portion of the third divider panel to a corresponding portion of a seat installed in the second cabin area.

13. The divider system of claim 12, further comprising at least one fastener extending through at least one corresponding opening in the seventh coupling portion and into at least one corresponding mounting point in the seat installed in the second cabin area to removably couple the rear end portion of the third divider panel to the seat.

14. The divider system of claim 10, wherein
the first divider panel is configured to restrict access between the first cabin area and the second cabin area;
the second divider panel is configured to restrict access between the second cabin area and the third cabin area; and
the third divider panel is configured to restrict access between the first section and the second section of the second cabin area.

15. The divider system of claim 10, wherein
the first cabin area is a front seating area of the vehicle;
the second cabin area is a rear seating area of the vehicle; and
the third cabin area is a cargo area of the vehicle.

16. A method of installing a divider system in a vehicle, including:
installing a first divider panel in an interior cabin of the vehicle, independent of a first support pillar and a second support pillar respectively provided at a first lateral side portion and a second lateral side portion of the vehicle, to separate a first cabin area from a second cabin area of the interior cabin, including:
coupling a first coupling portion at an upper end portion of the first divider panel to a roof portion of the interior cabin, including removably inserting a plurality of protrusions at the upper end portion of the first divider panel into a corresponding plurality of mounting points formed in a roof portion of the interior cabin; and
securing a second coupling portion at a lower end portion of the first divider panel to a floor portion of the interior cabin, including removably fastening the second coupling portion to at least one rail structure coupled to the floor portion of the interior cabin.

17. The method of claim 16, wherein securing the second coupling portion of the first divider panel to the floor portion of the interior cabin includes:
installing a plurality of fasteners through a plurality of openings in the second coupling portion and into a first bracket coupled to a first rail structure and a second bracket coupled to a second rail structure, the first rail structure securing a first seat in the first cabin area to the floor portion of the interior cabin, and the second rail structure securing a second seat in the first cabin area to the floor portion of the interior cabin.

18. The method of claim 16, further comprising installing a second divider panel in the interior cabin, to separate the second cabin area from a third cabin area of the vehicle, including:
positioning a third coupling portion at an upper end portion of the second divider panel between a frame and a door coupled to the frame, the frame being positioned between the second cabin area and the third cabin area, and the door being coupled to the frame for access to the third cabin area; and
installing a plurality of fasteners through a plurality of openings in a fourth coupling portion at a lower end portion of the second divider panel and into an upper end portion of a seat in the second cabin area.

19. The method of claim 18, further comprising installing a third divider panel in the second cabin area of the interior cabin, including:
coupling a fifth coupling portion at an upper end portion of the third divider panel to a roof portion of the interior cabin, including removably inserting a plurality of protrusions at the upper end portion of the third divider panel into a corresponding plurality of mounting points formed in the roof portion of the interior cabin; and
securing a sixth coupling portion at a lower end portion of the third divider panel to a floor portion of the interior cabin, including removably fastening the second coupling portion to the floor portion of the interior cabin.

20. The method of claim 19, wherein the third divider panel extends from the first divider panel to the second divider panel to separate the second cabin area into a first section and a second section.
